(19) United States
(12) Patent Application Publication
(10) Pub. No.: US 2016/0042185 A1
(43) Pub. Date: Feb. 11, 2016

(54) INFORMATION PROCESSING APPARATUS, STORAGE MEDIUM, AND INFORMATION PROCESSING METHOD

(71) Applicant: FUJI XEROX CO., LTD., Tokyo (JP)

(72) Inventors: Ryoko KOBORITA, Yokohama-shi (JP); Toru FUSE, Yokohama-shi (JP); Roshan THAPLIYA, Yokohama-shi (JP)

(21) Appl. No.: 14/922,606

(22) Filed: Oct. 26, 2015

Related U.S. Application Data
(63) Continuation of application No. PCT/JP2014/063174, filed on May 19, 2014.

(30) Foreign Application Priority Data
Jul. 5, 2013 (JP) 2013-141884

(51) Int. Cl. G06F 21/60; G06F 21/62

(52) U.S. Cl. CPC G06F 21/60; G06F 21/62

(57) ABSTRACT

To provide an information processing apparatus and a display control program that each determine a risk level of data owned by the apparatus based on information obtained from plural sensors included in the apparatus, an information processing apparatus 1 includes a situation determining unit 102 that determines a situation of the information processing apparatus 1 based on information obtained from an acceleration sensor 12 and a voice sensor 13; a risk level determining unit 103 that determines a risk level based on a change with time of the situation; a display range limiting unit 104 that limits a display range of document information 111 in accordance with the risk level determined by the risk level determining unit 103; and a displaying unit 105 that displays the document information 111 for the display range limited by the display range limiting unit 104.

### CROSS REFERENCE TO RELATED APPLICATION

This is a continuation of International Application No. PCT/JP2014/063174 filed on May 19, 2014, and claims priority from Japanese Patent Application No. 2013-141884, filed on Jul. 5, 2013.

### TECHNICAL FIELD

The present invention relates to an information processing apparatus, a storage medium, and an information processing method.

### BACKGROUND ART

As a technology of related art, there is suggested an information processing apparatus that forcibly deletes stored information if an action pattern of a user who owns the apparatus deviates from a standard action pattern.

### SUMMARY OF INVENTION

According to an aspect of the invention, there is provided an information processing apparatus including a situation determining unit that determines a situation of the apparatus based on information obtained from plural sensors included in the apparatus; and a risk level determining unit that determines a risk level for data owned by the apparatus based on a change with time of the situation.

### BRIEF DESCRIPTION OF DRAWINGS

FIG. 1 is a block diagram showing an example of a configuration of an information processing apparatus.

FIG. 2 is a schematic illustration showing an example of a configuration of a display screen when document information is displayed on a display.

FIG. 3 is that part (a) to part (d) of FIG. 3 are graphs each showing a specific example of a configuration of feature amount distribution information.

FIG. 4 is that part (a) and part (b) of FIG. 4 are schematic illustrations each showing a specific example of a configuration of action pattern information.

FIG. 5 is a schematic illustration showing a specific example of a configuration of security setting information.

FIG. 6 is that part (a) and part (b) of FIG. 6 are schematic illustrations each showing an example of a configuration of a display screen when document information is displayed on the display while a display range is limited.

FIG. 7 is a flowchart showing an example of an operation of the information processing apparatus.

### REFERENCE SIGNS LIST

1 information processing apparatus

10 controller

11 memory

12 acceleration sensor

13 voice sensor

14 display

15 operation unit

100 sensor information processing unit

101 feature amount extracting unit

102 situation determining unit

103 risk level determining unit

104 display range limiting unit

105 displaying unit

110 display control program

111 document information

112 feature amount distribution information

112a feature amount distribution information

112b feature amount distribution information

113 action pattern information

113a action pattern information

113b action pattern information

114 security setting information

114a security setting information

### DETAILED DESCRIPTION

### Exemplary Embodiment

### Configuration of Information Processing Apparatus

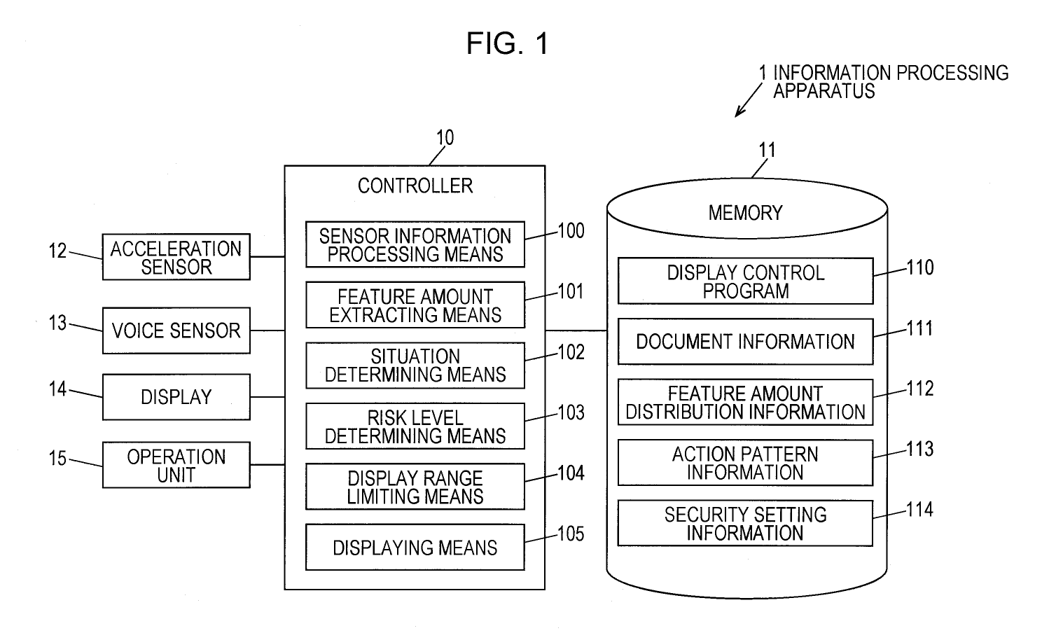

FIG. 1 is a block diagram showing an example of a configuration of an information processing apparatus 1.

The information processing apparatus 1 is a mobile information processing terminal such as a cell phone including an acceleration sensor 12 and a voice sensor 13. The information processing apparatus 1 determines the situation of the information processing apparatus 1 by using the acceleration sensor 12 and the voice sensor 13, and determines the risk level for document information 111 as data owned by the apparatus based on the situation. Further, the information processing apparatus 1 limits the content to be displayed on a display 14 in accordance with the risk level, and protects security of the document information 111. The acceleration sensor 12 and the voice sensor 13 are examples of sensors included in the apparatus, and other sensors may be used as long as the sensors can detect information for determining the situation of the information processing apparatus 1. Also, without limiting to the display of the document information 111, the content may be limited, for example, also when the document information 111 is printed, transmitted/received, or deleted.

The information processing apparatus 1 includes a controller 10 that is configured of a CPU (Central Processing Unit) etc., controls respective units, and executes various programs; a memory 11 configured of a storage medium, such as a HDD (Hard Disk Drive) or a flash memory, and being an example of a storage device that stores information; the acceleration sensor 12 that detects the acceleration of the information processing apparatus 1 in a single direction or plural axes directions; the voice sensor 13 that collects and detects voice; the display 14 such as a LCD (Liquid Crystal Display) that displays characters and images; and an operation unit 15, such as a touch pad or a switch, for operating the information processing apparatus 1.

The controller 10 functions as sensor information processing unit 100, feature amount extracting unit 101, situation determining unit 102, risk level determining unit 103, display range limiting unit 104, displaying unit 105, etc., by executing a display control program 110, which will be described later.

The sensor information processing unit 100 acquires a signal obtained by detecting the acceleration of the information processing apparatus 1 and a signal obtained by detecting the voice of environmental sound from the acceleration sensor 12 and the voice sensor 13, and executes conversion processing for converting the signals into information that the feature amount extracting unit 101 (described later) can handle.

The feature amount extracting unit 101 acquires information from the sensor information processing unit 100, and extracts predetermined feature amounts from the acceleration and the environmental sound of the information processing apparatus 1 detected by the acceleration sensor 12 and the voice sensor 13. The feature amounts to be extracted may be, for example, dispersion, entropy, FFT (Fast Fourier Transform) peak power, or FFT frequency.

The situation determining unit 102 generates feature amount distribution information 112 from the feature amounts extracted by the feature amount extracting unit 101, and determines the situation of the information processing apparatus 1 based on the feature amount distribution information 112. The feature amount extracting unit 101 acquires the feature amounts for a predetermined specific period (several seconds to several minutes) for generating the feature amount distribution information 112.

The risk level determining unit 103 determines the risk level of the information processing apparatus 1 based on the situation of the information processing apparatus 1 determined by the situation determining unit 102. Also, the risk level determining unit 103 further improves determination accuracy of the risk level by monitoring the situation of the information processing apparatus 1 on the time basis and referencing action pattern information 113.

The display range limiting unit 104 limits the display range of the document information 111 based on the risk level determined by the risk level determining unit 103 with reference to security setting information 114 (described later).

The displaying unit 105 displays the content of the document information 111 on the display 14 for a portion other than the display range limited by the display range limiting unit 104. If the display range limiting unit 104 does not limit the display range, the content of the document information 111 is directly displayed on the display 14.

The memory 11 stores the display control program 110, the document information 111, the feature amount distribution information 112, the action pattern information 113, the security setting information 114, etc.

The display control program 110 is a program that causes the controller 10 to function as the above-described unit 100 to 105 when the controller 10 executes the display control program 110.

The document information 111 is information of any of text information, image information, movie information, and other information, or a combination of such information, as an example of data owned by the information processing apparatus 1. The document information 111 may be any information as long as the content is displayed by the displaying unit 105.

The feature amount distribution information 112 is information in which the feature amounts extracted by the feature amount extracting unit 101 are plotted in a feature amount space.

The action pattern information 113 is information for defining the risk level based on a change with time of the situation of the information processing apparatus 1.

The security setting information 114 is information in which an item whose display is limited is set in accordance with the security level to counter the risk level. For example, setting is made such that the display of only an item with a high security level is limited if the risk level is low, and the display of an item with a high security level and an item with a low security level is limited if the risk level is high.

The information processing apparatus 1 is a mobile information processing terminal such as, for example, a cell phone; however, the information processing apparatus 1 may use a server device or a personal computer as long as it is portable.

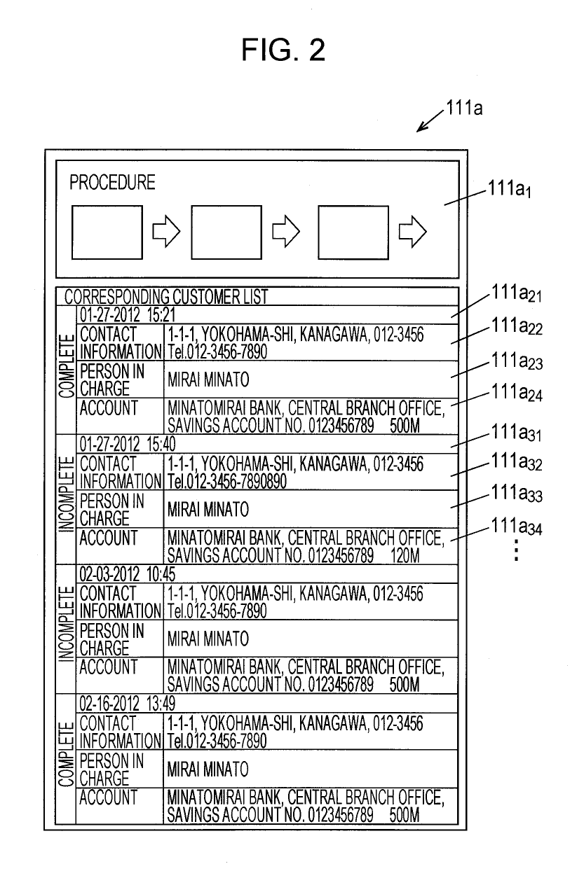

FIG. 2 is a schematic illustration showing an example of a configuration of a display screen when the document information 111 is displayed on the display 14.

Document information 111a has, as an example of items that configure the content, a region 111a1 in which a certain procedure is drawn with plural images, a region 111a21 in which registration date and time of customer information are written, a region 111a22 in which contact information of a customer is written, a region 111a23 in which a person in charge of the customer is written, a region 111a24 in which an account of the customer is written, and regions 111a31, 111a32, 111a33, 111a34, . . . , in which customer information of other customers are written similarly.

### Operation of Information Processing Apparatus

Next, an operation of this exemplary embodiment is described by dividing the operation into (1) basic operation, (2) determination operation, and (3) display operation.

### (1) Basic Operation

First, while a user holds the information processing apparatus 1, the user may act in various situations including walking, getting on an elevator, participating in a conference, working at a desk, or going out and getting on a train.

Also, the user operates the operation unit 15 of the information processing apparatus 1, and causes the display 14 to display the content of the document information 111 stored in the memory 11.

The acceleration sensor 12 of the information processing apparatus 1 detects the acceleration according to the action of the user, and the voice sensor 13 detects the environmental sound in the situation in which the user is present.

### (2) Determination Operation

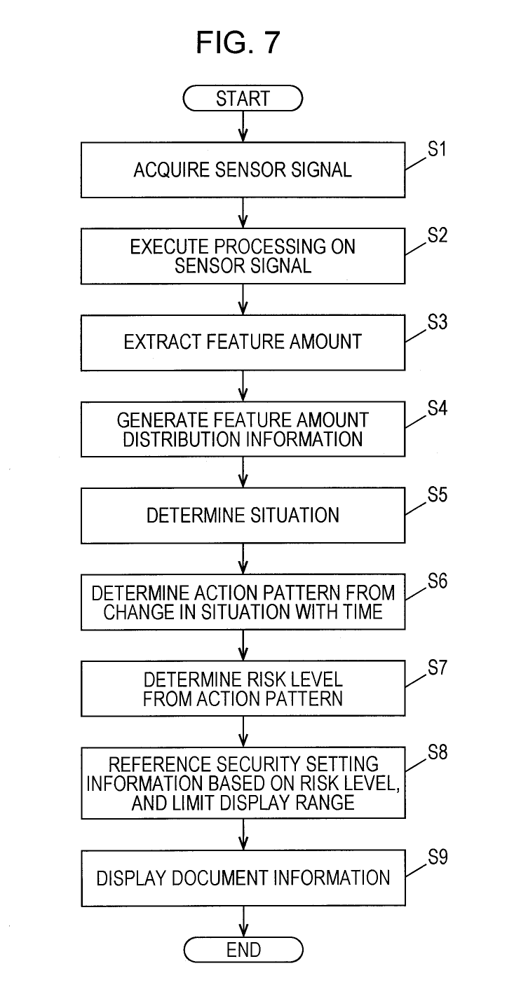

FIG. 7 is a flowchart showing an example of an operation of the information processing apparatus 1.

Then, the sensor information processing unit 100 acquires a signal obtained by detecting the acceleration of the information processing apparatus 1 and a signal obtained by detecting the voice of environmental sound from the acceleration sensor 12 and the voice sensor 13 (S1), and executes conversion processing for converting the signals into information that the feature amount extracting unit 101 can handle (S2).

Then, the feature amount extracting unit 101 receives information from the sensor information processing unit 100, and extracts feature amounts from the acceleration and the environmental sound of the information processing apparatus 1 detected by the acceleration sensor 12 and the voice sensor 13 (S3).

Then, the situation determining unit 102 generates feature amount distribution information 112 from the feature amounts extracted by the feature amount extracting unit 101 (S4), and determines the situation of the information processing apparatus 1 based on the feature amount distribution information 112 (S5).

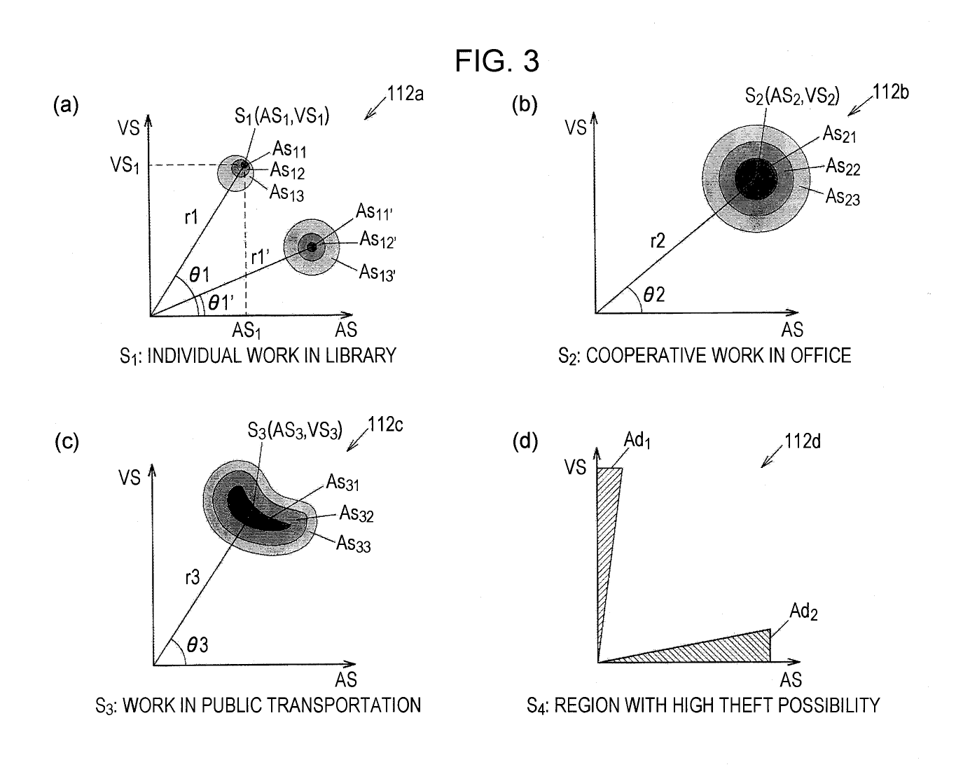

Part (a) to part (d) of FIG. 3 are graphs each showing a specific example of a configuration of the feature amount distribution information 112. In each of part (a) to part (d) of FIG. 3, the vertical axis plots a feature amount VS extracted from the acceleration sensor 12, and the horizontal axis plots a feature amount AS extracted from the voice sensor 13.

The situation determining unit 102 obtains feature amount distribution information 112a to 112c as shown in part (a) to part (c) of FIG. 3 as an example of the feature amount distribution information 112, from the feature amounts extracted by the feature amount extracting unit 101. The feature of distribution is previously learned. For example, when a distribution like the feature amount distribution information 112b is obtained, the situation determining unit 102 determines that the situation of the information processing apparatus 1 (user) is a situation S2 “cooperative work in office.”

Describing the feature amount distribution information 112b as an example, it is assumed that a region As21 having the center with a coordinate (AS2, VS2) indicates a region reliably determined as the situation S2 “cooperative work in office,” and determination accuracy is decreased in the order of a region As22 and a region As23. A region outside the region As23 is determined as not being the situation S2 “cooperative work in office.” Also, the coordinate (AS2, VS2) may be expressed as (r2, θ2) according to polar coordinates.

Also, regions As11 to As13 and regions As11′ to As13′ of the feature amount distribution information 112a are narrower than the regions As21 to As23 of the feature amount distribution information 112b. This is because, in terms of the characteristic of a situation S1 “individual work in library,” the motion of the user is smaller than the situation S2 “cooperative work in office” and the environmental sound is quiet.

Like regions Ad1 and Ad2 shown in part (d) of FIG. 3, the situation determining unit 102 may determine a case in which the information processing apparatus 1 is in a situation not corresponding to any of the feature amount distribution information 112a to 112c shown in part (a) to part (c) of FIG. 3, as an abnormal situation such as high theft possibility.

Next, the risk level determining unit 103 further improves determination accuracy of the risk level by monitoring the situation of the information processing apparatus 1 on the time basis and referencing action pattern information 113 (S6). In this case, “monitoring on the time basis” represents monitoring at least for a period (several minutes to several hours) that is longer than the predetermined specific period (several seconds to several minutes) required when the feature amount extracting unit 101 generates the feature amount distribution information 112.

The risk level determining unit 103 determines the risk level by monitoring the situation on the time basis, for example, with use of Expression (1) as follows.

$$\begin{matrix}Expression ( 1 ) & \\ {\sum }_{n = 1}^{T} {S}_{x} ( {AS}_{n} , {VS}_{n} ) \cdot W ( n ) < R & ( 1 )\end{matrix}$$

In Expression (1), T is a monitoring period, Sx is a feature amount, W(n) is a weight with a characteristic of a user added, and R is a predetermined threshold. In this case, W(n) is set as an example of a characteristic of a user such that the value is smaller when the user is careful than the value when the user is careless and such that the value is smaller in a relaxed period than the value of a busy period. That is, the risk level determining unit 103 may determine that the risk level is low if the feature amount Sx is monitored only for the period T with the characteristic W(n) of the user added and the feature amount Sx does not exceed the threshold R.

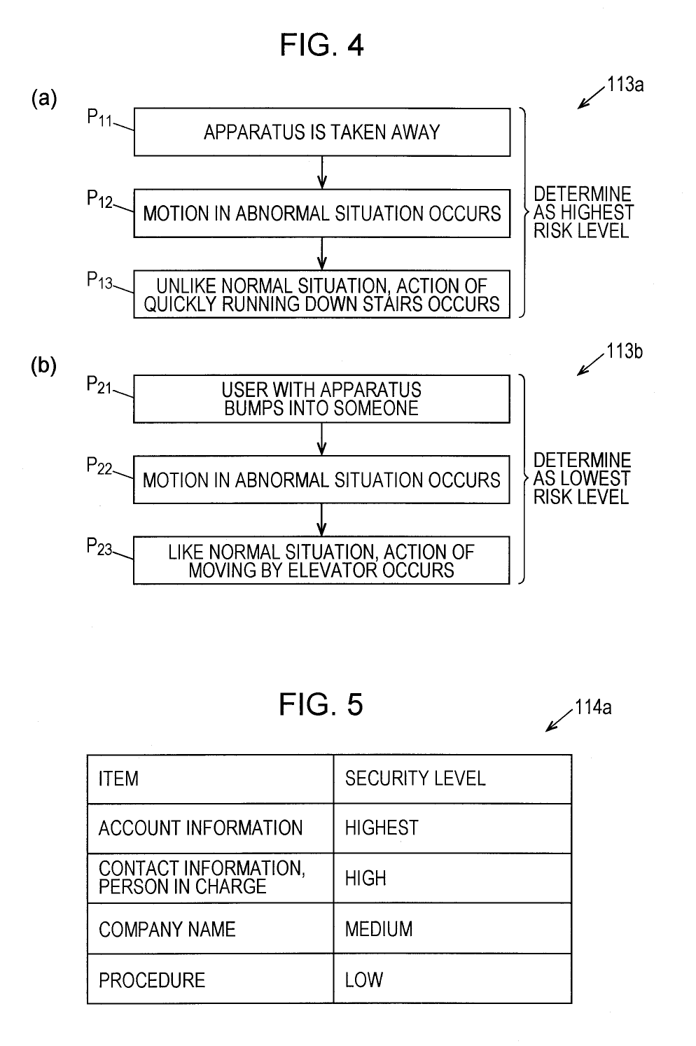

Part (a) and part (b) of FIG. 4 are schematic illustrations each showing a specific example of a configuration of the action pattern information 113.

As shown in part (a) of FIG. 4, if the action pattern is determined as an action pattern corresponding to action pattern information 113a, in which it is determined that the information processing apparatus 1 is taken away as a first element P11 of the action pattern, then it is determined that the information processing apparatus 1 is in an abnormal situation belonging to the region Ad1 shown in part (d) of FIG. 3 as a second element P12, and then it is determined that an action of quickly running down stairs is performed unlike normally running down stairs as a third element P13 (S6), the action pattern may correspond to a series of action patterns that an unknown person takes the information processing apparatus 1 away, then the unknown person performs a suspicious action so as not to be found by someone, and the unknown person runs away by using the stairs, with high possibility. Accordingly, the risk level determining unit 103 determines that the risk level of the information processing apparatus 1 is “the highest risk level” based on the action pattern (S7).

Also, for another example, as shown in part (b) of FIG. 4, if the action pattern is determined as an action pattern corresponding to action pattern information 113b, in which it is determined that a person with the information processing apparatus 1 bumps into someone as a first element P21 of the action pattern, then it is determined that the information processing apparatus 1 is in an abnormal situation belonging to the region Ad1 shown in part (d) of FIG. 3 as a second element P22, and then it is determined that an action of normally moving by elevator is performed as a third element P23, a series of action patterns is performed such that a user bumps into someone and has a suspicious action being different from an usual action when the user stands up, hence the risk level is expected to be high, however, the user becomes normal sense and moves by elevator. Accordingly, the risk level determining unit 103 determines that the risk level of the information processing apparatus 1 is “low risk level” based on the action pattern.

The elements P11 and P21 may be determined only in accordance with a change in acceleration without relying on the situation determining unit 102.

Alternatively, the risk level determining unit 103 may determine the risk level by using only the situation determined by the situation determining unit 102 regardless of the above-described action pattern. In this case, the risk level determining unit 103 determines that the situation is safe (low risk level) if the instantly acquired feature amount is included in any of the feature amount distribution information 112a to 112c, and it is determined that the situation has a high risk level if the feature amount is outside any of the regions.

### (3) Display Operation

Next, the display range limiting unit 104 limits the display range of the document information 111 based on the risk level such as “highest risk level” or “lowest risk level” determined by the risk level determining unit 103 with reference to the security setting information 114 (S8).

FIG. 5 is a schematic illustration showing a specific example of a configuration of the security setting information 114.

The security setting information 114 has an item the display of the document information 111 of which is limited, and a security level corresponding to the risk level determined by the risk level determining unit 103. The correspondence between the risk level and the security level is as follows. That is, in case of high risk level, even an item at a low security level is required to be protected, and hence the display of the item at the low security level is limited. In case of low risk level, an item at a high security level is protected and the other item is not required to be protected, and hence only the display of the item at the high security level is protected.

The displaying unit 105 displays the content of the document information 111 on the display 14 for a portion other than the display range limited by the display range limiting unit 104 (S9).

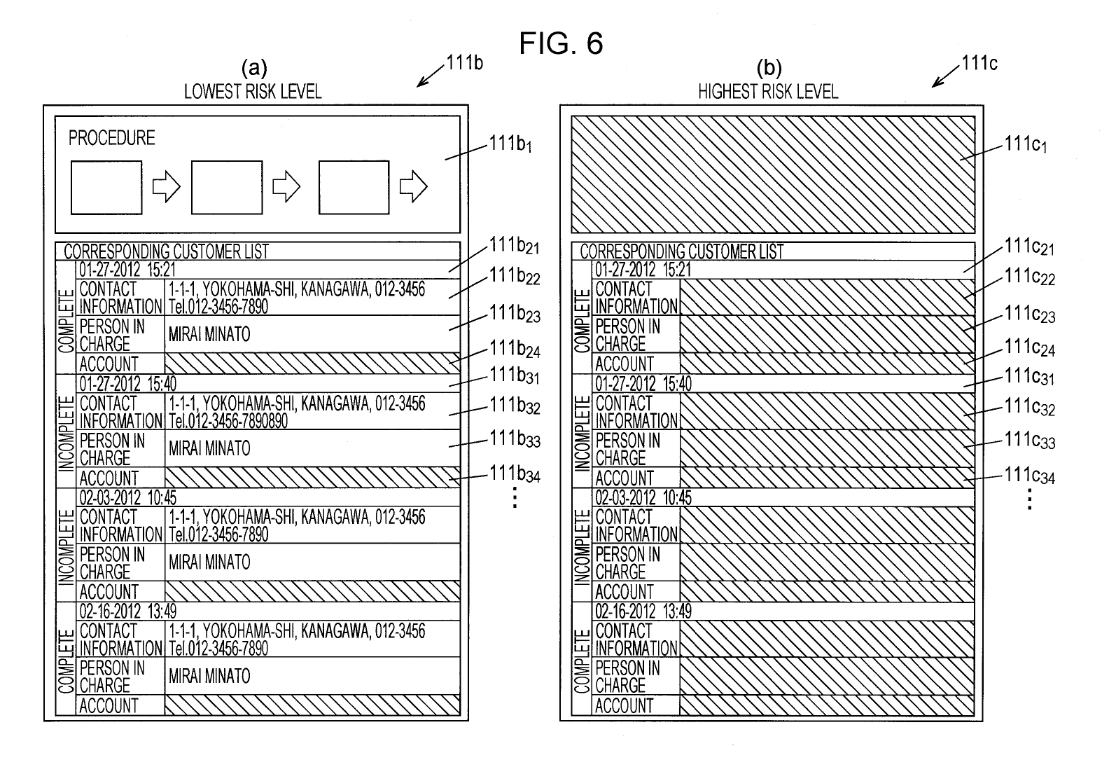

Part (a) and part (b) of FIG. 6 are schematic illustrations each showing an example of a configuration of a display screen when the document information 111 is displayed on the display 14 while a display range is limited.

Part (a) of FIG. 6 shows a case in which the risk level determining unit 103 makes determination as the “lowest risk level,” that is, only the display of an item at the “highest” security level is required to be limited. In particular, the display range limiting unit 104 limits the display of items 111b24, 111b34, 111b44, . . . , of document information 111b corresponding to an item “account information” whose security level is the “highest” in security setting information 114a. The method of limiting the display may be any method, such as leaving the item blank, shading the item, or tessellating the item, as long as the item is not visually recognized.

Also, part (b) of FIG. 6 shows a case in which the risk level determining unit 103 makes determination as the “highest risk level,” that is, the display of all items at the “low” to “highest” security levels is required to be limited. In particular, the display range limiting unit 104 limits the display of all items 111b1, 111b11, 111b12, 111b13, . . . , of document information 111b corresponding to items from an item “procedure” whose security level is “low” to an item “account information” whose security level is the “highest” in the security setting information 114a.

If the risk level determined by the risk level determining unit 103 is determined as erroneous detection thereafter, the display range limiting unit 104 cancels the above-described limitation for the display range, and a display range is limited based on the risk level that is newly determined.

Alternatively, after the display range is limited, a user may be requested to input a password or the like and thus the limitation for the display range may be canceled. Also, if the cancel procedure is not performed for a predetermined time, the document information 111 may be deleted.

Also, if the risk level determining unit 103 makes determination as the “highest risk level” and it can be definitely determined that the user lost the apparatus or the apparatus is stolen by someone, all document information 111 may be deleted.

### Advantageous Effects of Exemplary Embodiment

With the above-described exemplary embodiment, since feature amounts are extracted from information detected by plural sensors included in the apparatus, the situation of the information processing apparatus 1 is determined based on the feature amounts, and the risk level is determined based on a change with time of the situation, even if GPS is used and communication with a satellite is disconnected, the risk level of document information 111 owned by the apparatus may be determined based on the information obtained from the plural sensors included in the apparatus.

Also, since the risk level is determined in plural phases and the display range is limited in accordance with the risk level, the display content of the document information 111 can be controlled in accordance with the specific situation.

### Other Exemplary Embodiment

The invention is not limited to the above-described exemplary embodiment and may be modified in various forms within a scope not departing from the idea of the invention.

The functions of the respective unit 100 to 105 in the controller 10 are provided by the program according to the above-described exemplary embodiment. However, the functions of all or part of the respective unit may be provided by hardware such as ASIC. Also, the program used in the above-described exemplary embodiment may be stored in and provided by a storage medium such as a CD-ROM. Also, regarding the steps described according to the above-described exemplary embodiment, for example, the order of the steps may be changed, the steps may be partly deleted, and/or another step may be added, within a scope not changing the idea of the invention.

1. An information processing apparatus comprising:
a feature amount extracting unit that extracts predetermined feature amounts for a period based on information obtained from a plurality of sensors included in the apparatus;
a situation determining unit that generates feature amount distribution information from the feature amounts extracted by the feature amount extracting unit and determines a situation of the apparatus based on the feature amount distribution information; and
a risk level determining unit that determines a risk level for data owned by the apparatus based on a change with time of the situation.

2. The information processing apparatus according to claim 1, further comprising:
a limiting unit that limits a display range of the data in accordance with the risk level determined by the risk level determining unit; and
a displaying unit that displays the data for a portion other than the display range limited by the limiting unit.

3. The information processing apparatus according to claim 1, wherein the risk level determining unit deletes all or part of the data in accordance with the risk level.

4. A storage medium storing a program that causes a computer including a plurality of sensors to function as:
a feature amount extracting unit that extracts predetermined feature amounts for a period based on information obtained from a plurality of sensors included in the apparatus;
a situation determining unit that generates feature amount distribution information from the feature amounts extracted by the feature amount extracting unit and determines a situation of the computer based on the feature amount distribution information; and
a risk level determining unit that determines a risk level for data owned by the computer based on a change with time of the situation.

5. An information processing method comprising:
a feature amount extracting step of extracting predetermined feature amounts for a period based on information obtained from a plurality of sensors included in the apparatus;
a situation determining step of generating feature amount distribution information from the feature amounts extracted by the feature amount extracting step and determining a situation of an apparatus based on the feature amount distribution information; and
a risk level determining step of determining a risk level for data owned by the apparatus based on a change with time of the situation.
